(19) United States
(12) Patent Application Publication
(10) Pub. No.: US 2018/0143968 A1
(43) Pub. Date: May 24, 2018

(54) SYSTEM, METHOD AND NON-TRANSITORY COMPUTER READABLE STORAGE MEDIUM FOR CONVERSATION ANALYSIS

(71) Applicant: INSTITUTE FOR INFORMATION INDUSTRY, Taipei (TW)

(72) Inventors: Wei-Jen YANG, Kaohsiung City (TW); Yu-Shian CHIU, Taoyuan City (TW); Hui-I HSIAO, Yunlin County (TW)

(21) Appl. No.: 15/367,162

(22) Filed: Dec. 1, 2016

(30) Foreign Application Priority Data
Nov. 24, 2016 (TW) 105138686

(51) Int. Cl. G06F 17/27; G06F 17/30

(52) U.S. Cl. CPC G06F 17/279; G06F 17/30684; G06F 17/30542

(57) ABSTRACT

A conversation analysis method includes: receiving, by a processor, a conversation data including a plurality of sentences sorted by time; performing, by the processor, distributional clustering of context vectors to a plurality of words shown in the sentences to obtain a word order between the words; analyzing, by the processor, the words shown in the sentence to obtain a basic conversation matrix according to the word order; performing, by the processor, a fuzzy matching to the basic conversation matrix to obtain a conversation matrix based on the basic conversation matrix; detecting, by the processor, a topic trend according to the conversation matrix to determine the topic of the conversation data; and outputting, by the processor, the conversation matrix and the topic trend corresponding to the conversation data to a database.

### RELATED APPLICATIONS

This application claims priority to Taiwan Application Serial Number 105138686, filed Nov. 24, 2016, which is herein incorporated by reference.

### BACKGROUND

### Technical Field

The present disclosure relates to a system, a method and a non-transitory computer readable storage medium for conversation analysis, and in particular, to the system, the method and the non-transitory computer readable storage medium for conversation analysis able to analyze continuous conversation.

### Description of Related Art

In the current natural language processing, corpus linguistics are used to build the syntactic tree to analyze the content of the natural language. Since sentences using correct grammar and having complete structure are required in building the syntactic tree, most of the text corpus includes articles with complete structured sentences. However, in the group conversation nowadays, the sentences are often incomplete and the dialogue is the chat records between two or more users, and the model obtained from training traditional text corpus is not suitable.

Therefore, how to improve the current natural language analysis method to meet the characteristics of social conversation today to perform the analysis of the content of the language has been an important research topic in the field.

### SUMMARY

One aspect of the present disclosure is a conversation analysis method. The conversation analysis method includes: receiving, by a processor, a conversation data including a plurality of sentences sorted by time; performing, by the processor, distributional clustering of context vectors to a plurality of words shown in the sentences to obtain a word order between the words; analyzing, by the processor, the words shown in the sentence to obtain a basic conversation matrix according to the word order; performing, by the processor, a fuzzy matching to the basic conversation matrix to obtain a conversation matrix based on the basic conversation matrix; detecting, by the processor, a topic trend according to the conversation matrix to determine the topic of the conversation data; and outputting, by the processor, the conversation matrix and the topic trend corresponding to the conversation data to a database.

Another aspect of the present disclosure is a conversation analysis system. The conversation analysis system includes a storage device arranged and configured to store a database and program instructions, in which the database is configured to store a plurality of conversation data and a corresponding conversation matrix and a corresponding topic trend of each of the conversation data, and each of the conversation data includes a plurality of sentences sorted by time; and a processor electrically coupled to the storage device and arranged and configured to execute the program instructions to perform a conversation analysis method. The conversation analysis method includes: receiving, by the processor, one of the conversation data from the database; performing, by the processor, distributional clustering of context vectors to a plurality of words shown in the sentences of the conversation data to obtain a word order between the words; analyzing, by the processor, the words shown in the sentence to obtain a basic conversation matrix according to the word order; performing, by the processor, a fuzzy matching to the basic conversation matrix to obtain a conversation matrix based on the basic conversation matrix; detecting, by the processor, a topic trend according to the conversation matrix to determine the topic of the conversation data; and outputting, by the processor, the conversation matrix and the topic trend corresponding to the conversation data to the database.

Another aspect of the present disclosure is a non-transitory computer readable storage medium storing program instructions causing a processor to perform a conversation analysis method. The conversation analysis method includes: receiving, by the processor, at least one conversation data including a plurality of sentences sorted by time; performing, by the processor, distributional clustering of context vectors to a plurality of words shown in the sentences to obtain a word order between the words; analyzing, by the processor, the words shown in the sentence to obtain a basic conversation matrix according to the word order; performing, by the processor, a fuzzy matching to the basic conversation matrix to obtain a conversation matrix based on the basic conversation matrix; detecting, by the processor, a topic trend according to the conversation matrix to determine the topic of the conversation data; and outputting, by the processor, the conversation matrix and the topic trend corresponding to the conversation data to a database.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiments, with reference made to the accompanying drawings as follows:

FIG. 1 is a diagram illustrating a conversation analysis system according to some embodiments of the present disclosure.

FIG. 2A is a flowchart illustrating the conversation analysis method according to some embodiments of the present disclosure.

FIG. 2B is a detailed flowchart illustrating the step in the conversation analysis method according to some embodiments of the present disclosure.

FIG. 3A is a diagram illustrating an original word matrix according to some embodiments of the present disclosure.

FIG. 3B is a diagram illustrating the horizontal co-occurrence matrix according to some embodiments of the present disclosure.

FIG. 3C is a diagram illustrating the vertical co-occurrence matrix according to some embodiments of the present disclosure.

FIG. 3D is a diagram illustrating the total co-occurrence matrix according to some embodiments of the present disclosure.

FIG. 4A is a diagram illustrating the basic conversation matrix according to some embodiments of the present disclosure.

FIG. 4B is a diagram illustrating the conversation matrix according to some embodiments of the present disclosure.

FIG. 5 is a diagram illustrating the conversation matrix under test according to some embodiments of the present disclosure.

### DETAILED DESCRIPTION

Reference will now be made in detail to embodiments of the present disclosure, examples of which are described herein and illustrated in the accompanying drawings. While the disclosure will be described in conjunction with embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. It is noted that, in accordance with the standard practice in the industry, the drawings are only used for understanding and are not drawn to scale. Hence, the drawings are not meant to limit the actual embodiments of the present disclosure. In fact, the dimensions of the various features may be arbitrarily increased or reduced for clarity of discussion. Wherever possible, the same reference numbers are used in the drawings and the description to refer to the same or like parts for better understanding.

The terms used in this specification and claims, unless otherwise stated, generally have their ordinary meanings in the art, within the context of the disclosure, and in the specific context where each term is used. Certain terms that are used to describe the disclosure are discussed below, or elsewhere in the specification, to provide additional guidance to the practitioner skilled in the art regarding the description of the disclosure.

In the following description and in the claims, the terms “include” and “comprise” are used in an open-ended fashion, and thus should be interpreted to mean “include, but not limited to.” As used herein, the term “and/or” includes any and all combinations of one or more of the associated listed items.

In this document, the term “coupled” may also be termed “electrically coupled,” and the term “connected” may be termed “electrically connected.” “Coupled” and “connected” may also be used to indicate that two or more elements cooperate or interact with each other. It will be understood that, although the terms “first,” “second,” etc., may be used herein to describe various elements, these elements should not be limited by these terms. These terms are used to distinguish one element from another. For example, a first element could be termed a second element, and, similarly, a second element could be termed a first element, without departing from the scope of the embodiments.

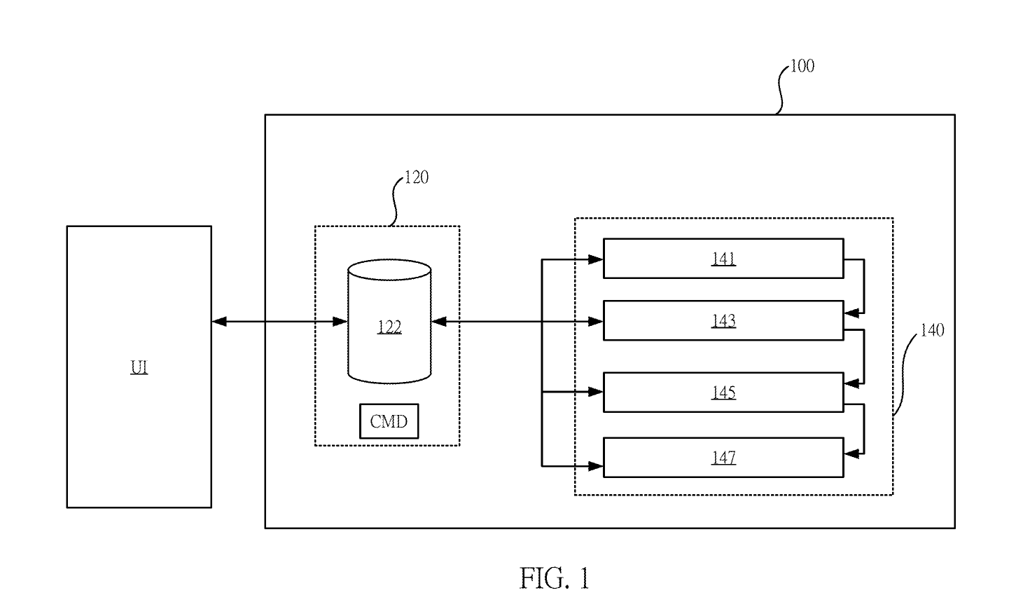

Reference is made to FIG. 1. FIG. 1 is a diagram illustrating a conversation analysis system 100 according to some embodiments of the present disclosure. As shown in FIG. 1, in some embodiments, the conversation analysis system 100 includes a storage device 120 and a processor 140.

Specifically, the storage device 120 is arranged and configured to store a database 122 and program instructions CMD. The database 122 is configured to store a plurality of conversation data D1-Dn and a corresponding conversation matrix and a corresponding topic trend of each of the conversation data D1-Dn. Specifically, each of the conversation data D1-Dn includes a plurality of sentences sorted by time, and the corresponding specific operation will be discussed in detail in the following paragraphs in accompanied with the drawings.

In addition, as shown in FIG. 1, in some embodiments, the conversation analysis system 100 is further configured to be coupled to the user interface UI, such that the user may execute following operations according to the analysis provided by the conversation analysis system 100. For example, the users may use the conversation analysis system 100 to analyze conversation topics on various digital platforms such as social network services, online discussion boards/forums, message boards, instant message systems, etc., and apply the analyzing result to the target marketing for different consumers before shopping, to simplify the shopping process during the online shopping, and to achieve smart question-answering customers services after shopping, to realize the simplification and automation of the above operations by analyzing the context of a continuous dialogue. In some embodiments, the user interface UI may include various forms such as websites, applications, or other interfaces having the conversation engine, but the present disclosure is not limited thereto.

In some embodiments, the processor 140 is electrically coupled to the storage device 120 and arranged and configured to execute the program instructions CMD to perform a conversation analysis method. Specifically, the analysis of the conversation patterns is achieved by the cooperation of the data collecting module 141, the context vectors clustering module 143, the conversation pattern mining and modeling module 145 and the trend detecting and pattern comparing module 147 in the processor 140 when the processor 140 performs the conversation analysis method according to the program instructions CMD.

Accordingly, the processor 140 may store the models and data required or obtained during the data training and data analyzing in the database 122, so as to interact with the user interface 200 through the database 122. For the convenience of the explanation, in the following paragraphs, the steps of the conversation analysis method performed by the processor 140 using the data collecting module 141, the context vectors clustering module 143, the conversation pattern mining and modeling module 145 and the trend detecting and pattern comparing module 147 will be explained in detail with the embodiments and accompanied drawings.

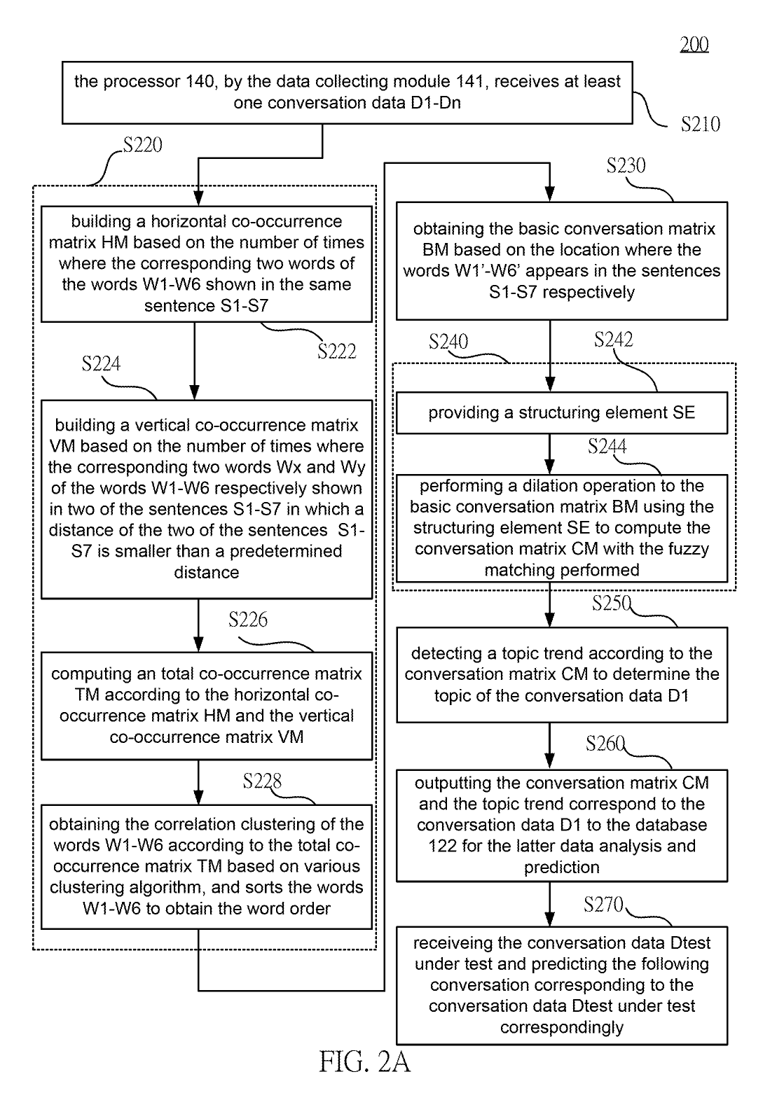

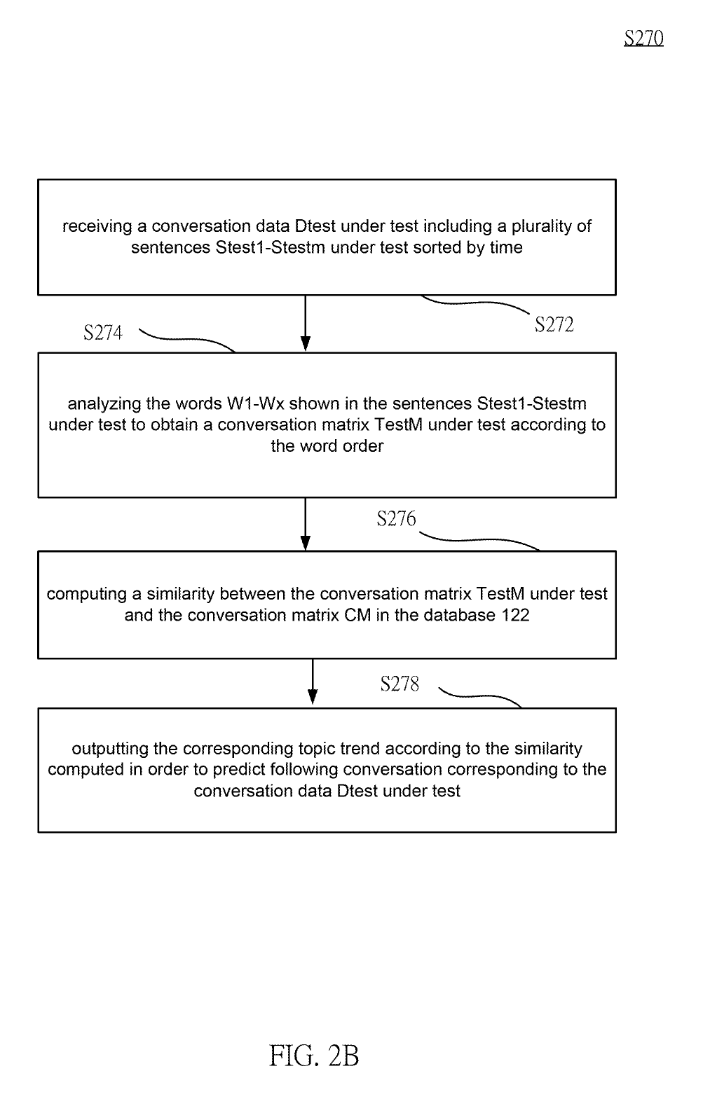

Reference is made to FIG. 2A and FIG. 2B together. FIG. 2A is a flowchart illustrating the conversation analysis method 200 according to some embodiments of the present disclosure. FIG. 2B is a detailed flowchart illustrating the step S270 in the conversation analysis method 200 according to some embodiments of the present disclosure. For better understanding and clarity of the explanation of the present disclosure, the conversation analysis method 200 shown in FIG. 2A and FIG. 2B is discussed in relation to the conversation analysis system 100 shown in FIG. 1, but is not limited thereto. It will be apparent to those skilled in the art that various modifications and variations can be made without departing from the scope or spirit of the disclosure.

As shown in FIG. 2A, in some embodiment, the conversation analysis method 200 includes steps S210, S220, S230, S240, S250, S260 and S270.

First, in the step S210, the processor 140, by the data collecting module 141, receives at least one conversation data D1-Dn. Specifically, the conversation analysis system 100 may collect the context of the group conversation from bulletin board systems, discuss forums, and various social network websites as the conversation data D1-Dn. As stated in the above paragraphs, each of the conversation data D1-DN (e.g., the conversation data D1) includes multiple sentences S1-Sm sorted by time, in which the sentences S1-Sm may be the conversation context in chronological order of the same discussion thread.

For example, in a thread discussing the cosmetic product on a social networking site, the data collecting module 141 collects the seven sentences S1-S7 including “Wondering whether the glowing of the X brand Primer is too much,” “X brand is not for oil-control, it only adding a layer of luster. Pick Y brand if you are looking for oil-control function,” “I think X brand still has the oil-control Effect, but not a major feature,” “Y brand is mainly for treating the acne,” “X brand does not perform well on oil-control in my feeling,” “Y brand really has a significant oil-control effect and does not trigger the acne,” and “Y brand Primer has the best effect, and it depends on the person when it comes to triggering the acne,” respectively for the conversation about the function and effects of different brands and products.

In some embodiments, the data collecting module 141 may build the word bank according to the collected sentences S1-S7, so as to obtain a plurality of words W1-Wx shown in the sentences S1-S7. For example, the data collecting module 141 may perform word segmentation to the collected context and use the result content as the word bank. In some embodiments, the data collecting module 141 may further eliminate some ordinary words such as “I,” “of,” etc., after the word segmentation, and use the remaining words for the word bank. In addition, in some other embodiments, the data collecting module 141 may also collect specific terms in specific fields and frequently used words in the field for the word bank in accompanied with the words in the group conversation contents.

For example, the data collecting module 141 may choose six words W1-W6 to build the word bank according to the above sentences S1-S7, in which the words W1-W6 are “X brand,” “oil-control,” “Y brand,” “acne,” “primer,” and “effect.”

Next, in the step S220, the processor 140 performs, by the context vectors clustering module 143, distributional clustering of context vectors to words W1-W6 shown in the sentences S1-S7 to obtain a word order between the words W1-W6.

Specifically, during the process of converting natural language in the way of vectors, different distributional clustering and sorting sequences will impact the latter comparison and analyzation. Thus, in the step S220, the context vectors clustering module 143 may obtain the word order between the words W1-W6 for the convenience of the following operations.

In some embodiments, obtaining the word order between the words W1-W6 in the step S220 may further includes steps S222, S224, S226, and S228.

In the step S222, the context vectors clustering module 143 builds a horizontal co-occurrence matrix HM based on the number of times where the corresponding two words of the words W1-W6 shown in the same sentence S1-S7.

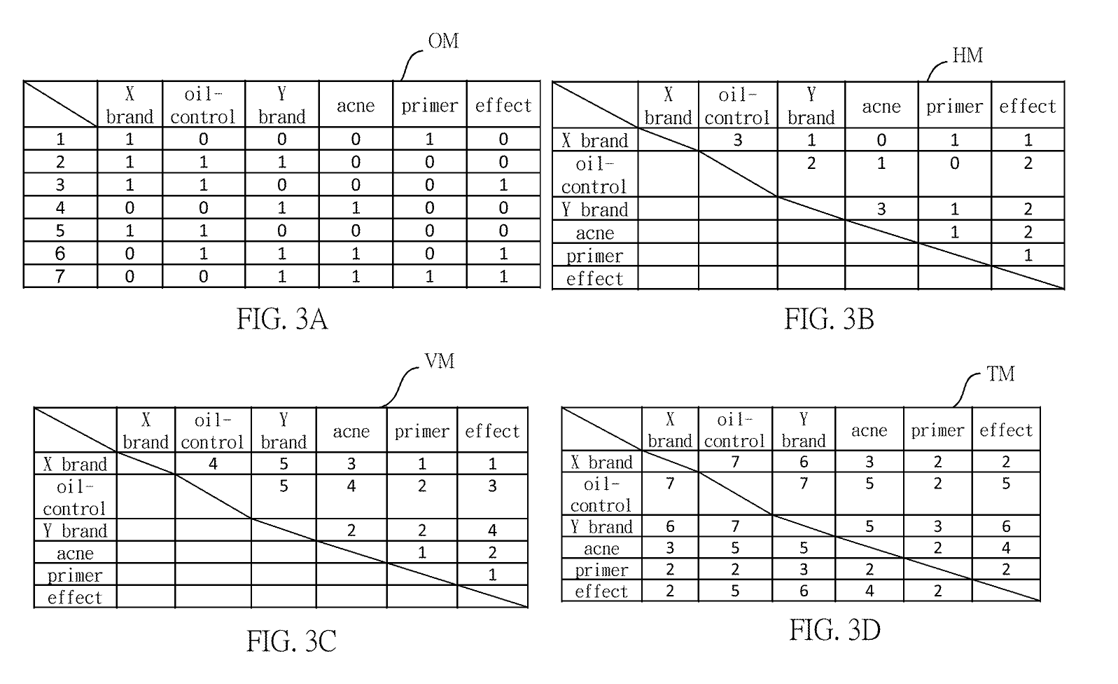

Reference is made to FIG. 3A and FIG. 3B. FIG. 3A is a diagram illustrating an original word matrix OM according toc some embodiments of the present disclosure, and FIG. 3B is a diagram illustrating the horizontal co-occurrence matrix HM according to some embodiments of the present disclosure. As shown in the FIG. 3A, the original word matrix OM may be obtained based on whether the corresponding words W1-W6 are shown in the sentences S1-S7 respectively, in which the value of OM(x,y) being 1 indicates the word Wy is shown in the sentence Sx. For example, the word W1, “X brand”, the word W5 “primer,” are shown in the sentence S1 “Wondering whether the glowing of the X brand Primer is too much.” Therefore, the value of OM(1,1) and OM(1,5) are 1, and the value of other cell OM(1,2), OM(1,3), OM(1,4) and OM(1,6) in the row is 0. The rule is applied to the values in other rows and thus further explanation is omitted for the sake of brevity.

As shown in FIG. 3B, in the horizontal co-occurrence matrix HM, the value of HM(x,y) indicates the number of times where the corresponding two words Wx and Wy of the words W1-W6 shown in the same one of the sentences S1-S7. For example, the word W1, “X brand” and the word W2 “oil-control” co-occur in three sentences S2, S3 and S5, and thus the value of HM(1,2) is 3. Similarly, the word W1, “X brand” and the word W3 “Y brand” only co-occur in one sentence S2, and thus the value of HM(1,3) is 1, and other values apply the same rule and thus further explanation is omitted for the sake of brevity.

Accordingly, the context vectors clustering module 143 may build the horizontal co-occurrence matrix HM indicating whether the words W1-W6 often occurs in the same sentence, so as to judge the degree of association between the words W1-W6.

Next, in the step S224, the context vectors clustering module 143 builds a vertical co-occurrence matrix VM based on the number of times where the corresponding two words Wx and Wy of the words W1-W6 respectively shown in two of the sentences S1-S7 in which a distance of the two of the sentences S1-S7 is smaller than a predetermined distance. Reference is made to FIG. 3C. FIG. 3C is a diagram illustrating the vertical co-occurrence matrix VM according to some embodiments of the present disclosure.

Compared to the horizontal co-occurrence matrix HM, the vertical co-occurrence matrix VM indicates whether the words W1-W6 often occurs in the adjacent context, in the different sentences in the overall conversation within a distance along a specific direction, so as to judge the degree of association between the words W1-W6. For example, the above mentioned distance may be configured to within 1 sentence, 2 sentences or any other values.

Alternatively stated, VM(x,y) indicates the number of times where the corresponding two words Wx and Wy of the words W1-W6 shown in the different sentences S1-S7 within a distance along the specific direction in the same conversation.

For example, in some embodiments the direction may be configured to the downward direction, and the predetermined distance is 1 sentence. Accordingly, since the word W1, “X brand” and the word W2 “oil-control” respectively occur in the adjacent sentences S1 and S2, and the word W1, “X brand” occurs in the sentence S2 when the word W2 “oil-control” occurs in the sentence S3 first, then the word W1, “X brand” occurs in the sentence S3 when the word W2 “oil-control” occurs in the sentence S2, and the word W1, “X brand” and the word W2 “oil-control” respectively occur in the adjacent sentences S5 and S6, the number of times where the corresponding two words W1 and W2 of shown in the different sentences S1-S7 within the distance value 1 along the downward direction in the same conversation is four, and the value of VM(1,2) is 4.

Similarly, the word W4 “acne” and the word W5 “primer” only respectively occur in the adjacent sentences S6 and S7 once, the thus the value of VM(4,5) is 1, and other values apply the same rule and thus further explanation is omitted for the sake of brevity.

Thus, the context vectors clustering module 143 may compute the degree of association between words W1-W6 according to the horizontal co-occurrence matrix HM and the vertical co-occurrence matrix VM.

Specifically, in the step S226, the context vectors clustering module 143 computes an total co-occurrence matrix TM according to the horizontal co-occurrence matrix HM and the vertical co-occurrence matrix VM.

Reference is made to FIG. 3D. FIG. 3D is a diagram illustrating the total co-occurrence matrix TM according to some embodiments of the present disclosure.

In some embodiments, the context vectors clustering module 143 may multiply the horizontal co-occurrence matrix HM and the vertical co-occurrence matrix VM by their rating respectively, and sum up the value to compute the total co-occurrence matrix TM. In the embodiments shown in FIG. 3D, the context vectors clustering module 143 sets the ratings both to be 1 to compute the total co-occurrence matrix TM, but the present disclosure is not limited thereto. The ratings of the horizontal co-occurrence matrix HM and the vertical co-occurrence matrix VM may be respectively adjusted according to actual requirements.

Finally, in the step S228, after the vector of the words W1-W6 are obtained by the total co-occurrence matrix TM, the context vectors clustering module 143 may obtain the correlation clustering of the words W1-W6 according to the total co-occurrence matrix TM based on various clustering algorithm, and sorts the words W1-W6 to obtain the word order.

For example, in some embodiments, the clustering algorithm may divide the words W1-W6 into two groups according to the total co-occurrence matrix TM, in which the words W1, W2, W3, and W6 are in one group and the words W4 and W5 are in another. Then, the words W1, W2, W3, and W6 in the group may be used to be the vertices of a complete graph, and the Hamilton path may be applied to put the words with high relevance in adjacent. Similarly, between multiple groups, the centroid of each group may be respectively used to be the vertices of the complete graph, and the Hamilton path may be applied to put the groups with high relevance in adjacent.

Accordingly, by proper algorithm, the word order of the word W1-W6 is obtained. For example, after putting the words with high relevance in adjacent, the re-sorted words W1′ “oil-control”, W2′ “Y brand”, W3′ “X brand”, W4′ “effect”, W5′ “acne”, and W6′ “primer.”

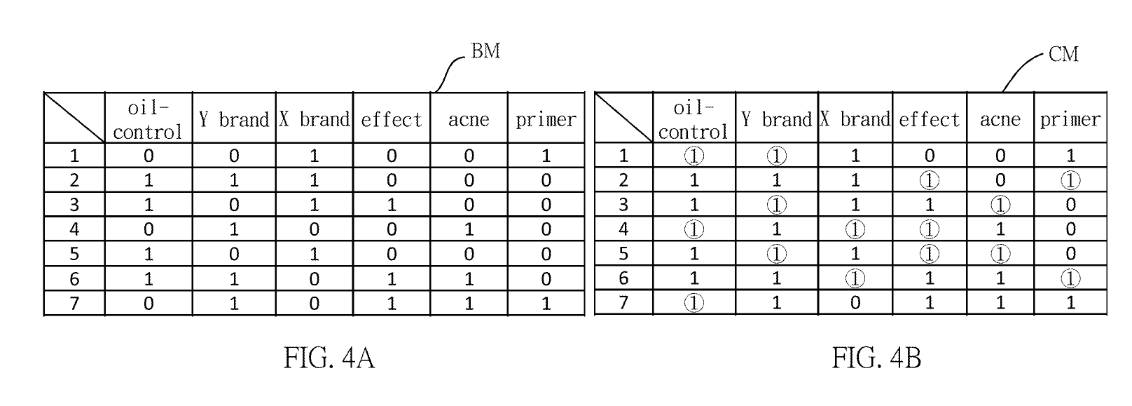

Next, in the step S230, the processor 140, by the conversation pattern mining and modeling module 145, analyzes the words W1′-W6′ shown in the sentence S1-S7 to obtain the basic conversation matrix BM according to the word order. Reference is made to FIG. 4A. FIG. 4A is a diagram illustrating the basic conversation matrix BM according to some embodiments of the present disclosure.

In some embodiments, in the step S230, the conversation pattern mining and modeling module 145 re-sorts the words W1-W6 to words W1′-W6′ based on the word order, and then obtains the basic conversation matrix BM based on the location where the words W1′-W6′ appears in the sentences S1-S7 respectively.

As shown in FIG. 4A, the basic conversation matrix BM may be obtained based on whether the corresponding re-sorted words W1′-W6′ are shown in the sentences S1-S7 respectively, in which the value of BM(x,y) being 1 indicates the word Wy′ is shown in the sentence Sx. For example, the word W3′, “X brand”, the word W6′ “primer,” are shown in the sentence S1 “Wondering whether the glowing of the X brand Primer is too much.” Therefore, the value of BM(1,3) and BM(1,6) are 1, and the value of other cell BM(1,1), BM(1,2), BM(1,4) and BM(1,5) in the row is 0. The rule is applied to the values in other rows and thus further explanation is omitted for the sake of brevity.

Next, in the step S240, the processor 140, by the conversation pattern mining and modeling module 145, performs a fuzzy matching to the basic conversation matrix BM to obtain a conversation matrix CM based on the basic conversation matrix BM. Reference is made to FIG. 4B. FIG. 4B is a diagram illustrating the conversation matrix CM according to some embodiments of the present disclosure.

In some embodiments, the step S240 of obtaining the conversation matrix CM further includes steps S242 and S244.

In the step S242, the conversation pattern mining and modeling module 145 provides a structuring element SE. Next, in the step S244, the conversation pattern mining and modeling module 145 performs a dilation operation to the basic conversation matrix BM using the structuring element SE to compute the conversation matrix CM with the fuzzy matching performed.

As shown in FIG. 4B, the structuring element SE may be a column vector [1, 1, 1]. In some embodiments, the dilation operation B⊕A may be expressed as:

B⊕A={z|[(Â)_{z}∩B≠ϕ]}

Where (Â)_{z} denotes the reflection of A and shift for z units. The issue of insufficient data occurs during the conversation context searching if the data is compared directly, and the words and terms used in the previous sentences are often omitted in the following sentences in the conversation. Thus, the conversation pattern mining and modeling module 145 may perform dilation operation in mathematical morphology to the basic conversation matrix BM to achieve the fuzzy matching, so as to get more responsive alternatives of conversation, and to obtain the corresponding conversation matrix CM.

Next, in the step S250, the processor 140, by the trend detecting and pattern comparing module 147, detects a topic trend according to the conversation matrix CM to determine the topic of the conversation data D1. For example, in some embodiments, the step S250 includes computing barycentric coordinates of the conversation matrix CM, in order to determine the topic trend of the conversation data D1 according to the barycentric coordinates. Specifically, after the relevant clustering stated above, the barycenter of the conversation matrix CM may be used to indicate the main idea and topic of the above conversation.

In addition, in some embodiments, if the corresponding locations of the barycenter are significantly different when comparing the similarities of the conversation patterns, the conversation topic is relatively different. Accordingly, the trend detecting and pattern comparing module 147 may exclude the point where the barycenter are significantly different so as to reduce the required computation when searching the most similar conversation context in the database 122.

For example, in some embodiments, by comparing the barycenter, two conversations may be quickly determined whether they discuss the similar topic, and thus detecting and determining the conversation topic. In another aspect, if there are two or more topics in one conversation, the conversation may be divided based on different topics by detecting the shifting of the barycenter in few sentences.

Specifically, the barycentric coordinates may be expressed as:

$$( \frac{{m}_{10}}{{m}_{00}} , \frac{{m}_{01}}{{m}_{00}} )$$

Where m₀₀ denotes the zero order moment and the sum of all the value 1 cell, m₁₀ and m₀₁ denote the first order moment in two dimension respectively, and the equation may be expressed as:

$${m}_{pq} = {\sum }_{i = 1}^{M} {\sum }_{j = 1}^{N} {i}^{p} {j}^{q} CM ( i , j )$$

Where the size of the conversation matrix CM is M×N, CM(i,j) denotes the value of the location (i,j) in the conversation matrix CM, and p, q are the order of the moment respectively.

For example, according to the conversation matrix CM shown in FIG. 4B, if the upper-left corner is defined as (0,0), then the result derived by the above equations are:

m₀₀=35

m₁₀=0×4+1×5+2×5+3×5+4×5+5×6+6×5=110

m₀₁=0×6+1×6+2×6+3×6+4×5+5×4=76

Accordingly, the barycentric coordinates of the conversation matrix CM is (110/35,76/35).

Next, in the step S260, the processor 140 may output the conversation matrix CM and the topic trend (i.e., the location of the barycenter) correspond to the conversation data D1 to the database 122 for the latter data analysis and prediction.

For example, in some embodiments, the conversation analysis method 200 further includes step S270. In the step S270, the conversation analysis system 100 receives the conversation data Dtest under test and predicts the following conversation corresponding to the conversation data Dtest under test correspondingly.

Reference is made to FIG. 2B. As shown in FIG. 2B, specifically, the steps S270 may include steps S272, S274, S276 and S278.

In the step S272, the processor 140 receives, by the data collecting module 141, a conversation data Dtest under test including a plurality of sentences Stest1-Stestm under test sorted by time. For example, the sentences Stest1-Stestm under test may be “How is the X brand primer?,” “Y brand has good oil-control effect, and X brand does not take oil-control as the feature,” “I don't feel X brand perform oil-control in use,” and “Y brand really has fantastic oil-control effect and does not trigger acne.”

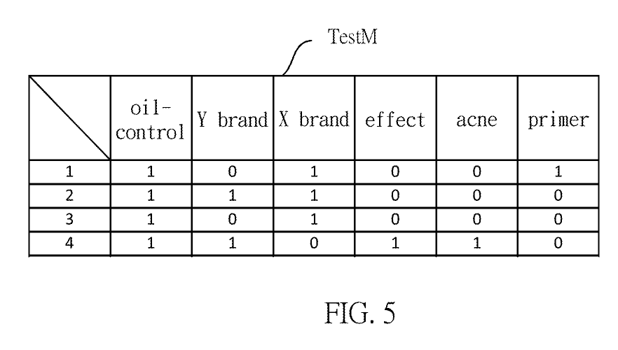

Next, in the step S274, the processor 140 analyzes, by the context vectors clustering module 143, the words W1-Wx shown in the sentences Stest1-Stestm under test to obtain a conversation matrix TestM under test according to the word order. It is noted that the specific process obtain the conversation matrix TestM under test according to the word order is similar to the way of obtaining the basic conversation matrix BM and thus further explanation is omitted herein for the sake of brevity. Reference is made to FIG. 5. FIG. 5 is a diagram illustrating the conversation matrix TestM under test according to some embodiments of the present disclosure.

Next, in the step S276, the processor 140 computes, by the trend detecting and pattern comparing module 147, a similarity between the conversation matrix TestM under test and the conversation matrix CM in the database 122.

Specifically, in some embodiments, when determining the similarity between two matrixes B₁ and B₂, the similarity SB₁B₂ of B₁ to B₂ and the similarity SB₂B₁ of B₂ to B₁ may be computed respectively, and the average value may be used as the similarity between the matrixes B₁ and B₂. The similarity SB₁B₂ and the similarity SB₂B₁ may be expressed respectively as:

SB₁B₂=P(B₂(i,j)=1|B₁(i,j)=1)

SB₂B₁=P(B₁(i,j)=1|B₂(i,j)=1)

Where B₁(i,j) and B₂(i,j) are values of B₁ and B₂ at the location (i,j). According to the above equations, the trend detecting and pattern comparing module 147 computes the similarity between the conversation matrix TestM under test and the conversation matrix CM in the database 122.

It is noted that the pixel matching similarity calculation method mentioned above is only one example of various implementation methods of the present disclosure and not meant to limit the present disclosure. One skilled in the art may also obtain the similarity between the conversation matrix TestM under test and the conversation matrix CM by various similarity or relevance calculation methods.

Finally, in the step S278, the processor 140, by the trend detecting and pattern comparing module 147, may output the corresponding topic trend according to the similarity computed in order to predict following conversation corresponding to the conversation data Dtest under test. For example, when the similarity is higher than a target value, the trend detecting and pattern comparing module 147 may determine the topic and the context of the conversation data Dtest under test is close to the conversation matrix CM, and output the topic trend or the relating data to the conversation engine, so as to output corresponding content to the user interface UI.

Thus, by the co-operation of the modules in the above steps S210-S270, the conversation analysis system 100 may collect the context of the group conversation, and then perform distributional clustering based on co-occurrence of the words to construct conversation pattern block to replace the corpus linguistics methods. Next, the fuzzy matching, comparison of the similar pattern of the conversation and the detection of the conversation topic trend to analyze the content and the topic trend of the conversation are applied to predict the following content. The pattern of each conversation is stored, so as to provide various conversation pattern blocks to improve the accuracy.

It is noted that, while disclosed methods are illustrated and described herein as a series of acts or events, it will be appreciated that the illustrated ordering of such acts or events are not to be interpreted in a limiting sense. For example, some acts may occur in different orders and/or concurrently with other acts or events apart from those illustrated and/or described herein. In addition, not all illustrated acts may be required to implement one or more aspects or embodiments of the description herein. Further, one or more of the acts depicted herein may be carried out in one or more separate acts and/or phases.

By applying the various embodiments in the present disclosure, the following conversation may be predicted through analyzing the conversation records, so as to find the potential consumers for target marketing. In addition, the conversation analysis system 100 may also use the conversation engine to simplify the complicated shopping process during the online shopping by realizing easy shopping using natural conversation with the shopping system, and may also achieve smart question-answering customers services after shopping by assisting the repeated question-answering with the analysis of the meaning of the conversation and the detection of the topic trend.

Although the disclosure has been described in considerable detail with reference to certain embodiments thereof, it will be understood that the embodiments are not intended to limit the disclosure. It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A conversation analysis method comprising:
receiving, by a processor, a conversation data comprising a plurality of sentences sorted by time;
performing, by the processor, distributional clustering of context vectors to a plurality of words shown in the sentences to obtain a word order between the words;
analyzing, by the processor, the words shown in the sentence to obtain a basic conversation matrix according to the word order;
performing, by the processor, a fuzzy matching to the basic conversation matrix to obtain a conversation matrix based on the basic conversation matrix;
detecting, by the processor, a topic trend according to the conversation matrix to determine the topic of the conversation data; and
outputting, by the processor, the conversation matrix and the topic trend corresponding to the conversation data to a database.

2. The conversation analysis method of claim 1, wherein the step of obtaining the word order between the words comprises:
building, by the processor, a horizontal co-occurrence matrix based on the number of times where the corresponding two words of the words shown in the same sentence;
building, by the processor, a vertical co-occurrence matrix based on the number of times where the corresponding two words of the words respectively shown in two sentences wherein a distance of the two sentences is smaller than a predetermined distance;
computing, by the processor, an total co-occurrence matrix according to the horizontal co-occurrence matrix and the vertical co-occurrence matrix; and
obtaining, by the processor, the correlation clustering of the words according to the total co-occurrence matrix based on clustering algorithm, and sorting the words to obtain the word order.

3. The conversation analysis method of claim 1, wherein the step of obtaining the basic conversation matrix according to the word order comprises:
re-sorting the words, by the processor, based on the word order, and then obtaining the basic conversation matrix based on the location where the words appears in the sentences respectively.

4. The conversation analysis method of claim 3, wherein the step of obtaining the conversation matrix based on the basic conversation matrix comprises:
providing, by the processor, a structuring element; and
performing a dilation operation to the basic conversation matrix using the structuring element to compute the conversation matrix with the fuzzy matching performed.

5. The conversation analysis method of claim 1, wherein the step of detecting the topic trend according to the conversation matrix comprises:
computing barycentric coordinates of the conversation matrix, in order to determine the topic trend of the conversation data according to the barycentric coordinates.

6. The conversation analysis method of claim 1, further comprising:
receiving, by the processor, a conversation data under test comprising a plurality of sentences under test sorted by time;
analyzing, by the processor, the words shown in the sentences under test to obtain a conversation matrix under test according to the word order;
computing, by the processor, a similarity between the conversation matrix under test and the conversation matrix in the database; and
outputting, by the processor, the corresponding topic trend according to the similarity computed in order to predict following conversation corresponding to the conversation data under test.

7. A conversation analysis system, comprising:
a storage device arranged and configured to store a database and program instructions, wherein the database is configured to store a plurality of conversation data and a corresponding conversation matrix and a corresponding topic trend of each of the conversation data, and each of the conversation data comprises a plurality of sentences sorted by time; and
a processor electrically coupled to the storage device and arranged and configured to execute the program instructions to perform a conversation analysis method, wherein the conversation analysis method comprises:
receiving, by the processor, one of the conversation data from the database;
performing, by the processor, distributional clustering of context vectors to a plurality of words shown in the sentences of the conversation data to obtain a word order between the words;
analyzing, by the processor, the words shown in the sentence to obtain a basic conversation matrix according to the word order;
performing, by the processor, a fuzzy matching to the basic conversation matrix to obtain a conversation matrix based on the basic conversation matrix;
detecting, by the processor, a topic trend according to the conversation matrix to determine the topic of the conversation data; and
outputting, by the processor, the conversation matrix and the topic trend corresponding to the conversation data to the database.

8. The conversation analysis system of claim 7, wherein the step of obtaining the word order between the words in the conversation analysis method performed by the processor comprises:
building, by the processor, a horizontal co-occurrence matrix based on the number of times where the corresponding two words of the words shown in the same sentence;
building, by the processor, a vertical co-occurrence matrix based on the number of times where the corresponding two words of the words respectively shown in two sentences wherein a distance of the two sentences is smaller than a predetermined distance;
computing, by the processor, an total co-occurrence matrix according to the horizontal co-occurrence matrix and the vertical co-occurrence matrix; and
obtaining, by the processor, the correlation clustering of the words according to the total co-occurrence matrix based on clustering algorithm, and sorting the words to obtain the word order.

9. The conversation analysis system of claim 7, wherein the step of obtaining the basic conversation matrix according to the word order in the conversation analysis method performed by the processor comprises:
re-sorting the words, by the processor, based on the word order, and then obtaining the basic conversation matrix based on the location where the words appears in the sentences respectively.

10. The conversation analysis system of claim 9, wherein the step of obtaining the conversation matrix based on the basic conversation matrix in the conversation analysis method performed by the processor comprises:
providing, by the processor, a structuring element; and
performing a dilation operation to the basic conversation matrix using the structuring element to compute the conversation matrix with the fuzzy matching performed.

11. The conversation analysis system of claim 7, wherein the step of detecting the topic trend according to the conversation matrix in the conversation analysis method performed by the processor comprises:
computing barycentric coordinates of the conversation matrix, in order to determine the topic trend of the conversation data according to the barycentric coordinates.

12. The conversation analysis system of claim 7, wherein the conversation analysis method performed by the processor further comprises:
receiving, by the processor, a conversation data under test comprising a plurality of sentences under test sorted by time;
analyzing, by the processor, the words shown in the sentences under test to obtain a conversation matrix under test according to the word order;
computing, by the processor, a similarity between the conversation matrix under test and the conversation matrix in the database; and
outputting, by the processor, the corresponding topic trend according to the similarity computed in order to predict following conversation corresponding to the conversation data under test.

13. A non-transitory computer readable storage medium storing program instructions causing a processor to perform a conversation analysis method, wherein the conversation analysis method comprises:
receiving, by the processor, at least one conversation data comprising a plurality of sentences sorted by time;
performing, by the processor, distributional clustering of context vectors to a plurality of words shown in the sentences to obtain a word order between the words;
analyzing, by the processor, the words shown in the sentence to obtain a basic conversation matrix according to the word order;
performing, by the processor, a fuzzy matching to the basic conversation matrix to obtain a conversation matrix based on the basic conversation matrix;
detecting, by the processor, a topic trend according to the conversation matrix to determine the topic of the conversation data; and
outputting, by the processor, the conversation matrix and the topic trend corresponding to the conversation data to a database.
